(19) United States
(12) Patent Application Publication
(10) Pub. No.: US 2013/0339051 A1
(43) Pub. Date: Dec. 19, 2013

(54) SYSTEM AND METHOD FOR GENERATING TEXTUAL REPORT CONTENT

(71) Applicant: George M. Dobrean, Waterloo (CA)

(72) Inventor: George M. Dobrean, Waterloo (CA)

(21) Appl. No.: 13/525,739

(22) Filed: Jun. 18, 2012

(51) Int. Cl. G06Q 50/24; G06F 17/21

(52) U.S. Cl. 705/3; 715/256

(57) ABSTRACT

A system and method for completing a medical record includes receiving a request for creating a medical record for a completed medical procedure. Text macros that are relevant to the completed medical procedure are retrieved. Each of the retrieved text macros have at least one text block. A report structure for reporting the completed medical procedure is selected. A text macro is selected from the retrieved text macros. A determination is made as to the compatibility between the selected report structure and the retrieved text macros. If the selected text macro is compatible, report sections indicated by the selected report structure are created and text blocks of the selected text macro are used to update the created report sections.

### FIELD

Exemplary embodiments described herein relate to systems and methods in the medical field. More specifically, they relate to a system and method for generating medical reports using text macros.

### INTRODUCTION

Medical reports, especially radiology reports, are an essential component of a patient's health record. They serve several purposes: medico-legal communication; a standard of comparison with other radiological procedures; a permanent record in the case of lost images; communication with other health professionals; a means of expediting the treatment; and a method to assist in formulating an accurate and precise clinical diagnosis.

The goal of any medical information technology system is to improve the quality of care. In this context, report completeness and consistency are generally desired. Medical reporting, especially in the radiology context, is a service used by other clinical specialties including general practice. Therefore medical and radiology reports are used by clinicians and general practitioners. Clinicians and general practitioners are interested in both efficient and effective diagnostic data gathering and diagnostic data analysis and statistics for patient care, research or administration.

### SUMMARY

The embodiments described herein provide in one aspect a method for completing a medical record comprising: receiving at a first client workstation a medical record creation request for at least a first completed medical procedure, the request indicating at least one medical procedure property of the first completed medical procedure; retrieving one or more first relevant text macros, each of the text macros comprising at least one text block; selecting a first report structure based on the at least one medical procedure property of the first completed medical procedure, the first report structure indicating a first set of one or more types of report sections for completing the medical record; receiving a first text macro selection request comprising a first selected text macro selected from the retrieved first relevant text macros; and determining whether the selected first text macro is compatible with the selected first report structure based on the types of report sections for the first selected report structure and the at least one text block of the selected first text macro.

The embodiments described herein provide in another aspect a system for creating a new text macro to be used for completing a medical record, the method comprising: receiving a text macro creation request for creating the new text macro; and for one or more populated report sections of a selected report structure: storing the content of the populated report section in a text block of the new text macro; and associating the text block with the report section type of the populated report section.

The embodiments described herein provide in another aspect A system for completing a medical record comprising: a memory for storing a plurality of instructions; a data storage device; and a processor coupled to the memory, the processor configured for:

receiving at a first client workstation a medical record creation request for at least a first completed medical procedure, the request indicating at least one medical procedure property of the first completed medical procedure;

retrieving one or more first relevant text macros, each of the text macros comprising at least one text block;

selecting a first report structure based on the at least one medical procedure property of the first completed medical procedure, the first report structure indicating a first set of one or more types of report sections for completing the medical record;

receiving a first text macro selection request comprising a first selected text macro selected from the retrieved first relevant text macros; and

determining whether the selected first text macro is compatible with the selected first report structure based on the types of report sections for the first selected report structure and the at least one text block of the selected first text macro.

The embodiments described herein provide in another aspect a system for creating a new text macro to be used for completing a medical record, the system comprising; a memory for storing a plurality of instructions; a data storage device; and a processor coupled to the memory, the processor configured for:

receiving a text macro creation request for creating the new text macro; and

for one or more populated report sections of a selected report structure:

storing the content of the populated report section in a text block of the new text macro; and

associating the text block with the report section type of the populated report section.

Further aspects and advantages of the embodiments described will appear from the following description taken together with the accompanying drawings.

### DRAWINGS

For a better understanding of the embodiments described herein and to show more clearly how they may be carried into effect, reference will now be made, by way of example only, to the accompanying drawings which show at least one exemplary embodiment, and in which:

FIG. 1 is a block diagram of the components of an exemplary embodiment of a system for generating medical reports using text macros;

FIG. 2 is a schematic diagram of an exemplary input screen for entering observations for a medical procedure;

FIG. 3 is a schematic diagram of an exemplary text macro;

FIG. 4 is a flowchart illustrating the general operational steps of an exemplary embodiment of the medical report generation system for completing a medical record;

FIG. 5 is a flowchart illustrating the general operational steps of an exemplary embodiment for retrieving text macros;

FIG. 6 is a flowchart illustrating the general operational steps of an exemplary embodiment for determining whether a selected text macro is compatible with a selected report structure.

FIG. 7 is a flowchart illustrating the general operational steps of an exemplary embodiment for updating a report section of a report structure.

FIG. 8 is a flowchart illustrating the general operational steps of an exemplary embodiment for completing a medical record;

FIG. 9 is a flowchart illustrating the general operational steps of an exemplary embodiment for selecting a normal report; and

FIG. 10 is a flowchart illustrating the general operational steps of an exemplary embodiment for creating a text macro.

### DESCRIPTION OF VARIOUS EMBODIMENTS

It will be appreciated that, for simplicity and clarity of illustration, where considered appropriate, reference numerals may be repeated among the figures to indicate corresponding or analogous elements or steps. In addition, numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way but rather as merely describing the implementation of the various embodiments described herein.

The embodiments of the systems and methods described herein may be implemented in hardware or software, or a combination of both. However, preferably, these embodiments are implemented in computer programs executing on programmable computers, each comprising at least one processor, a data storage system (including volatile and non-volatile memory and/or storage elements), at least one input device, and at least one output device. For example and without limitation, the programmable computers may be a mainframe computer, server, personal computer, laptop, personal data assistant, cellular telephone, smartphone, or tablet device. Program code is applied to input data to perform the functions described herein and generate output information. The output information is applied to one or more output devices in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer for configuring and operating the computer when the storage media or device is read by the computer to perform the procedures described herein. The system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer-usable instructions for one or more processors. The medium may be provided in various forms including one or more diskettes, compact disks, tapes, chips, wireline transmissions, satellite transmissions, internet transmission or downloadings, magnetic and electronic storage media, digital and analog signals, and the like. The computer-usable instructions may also be in various forms including compiled and non-compiled code.

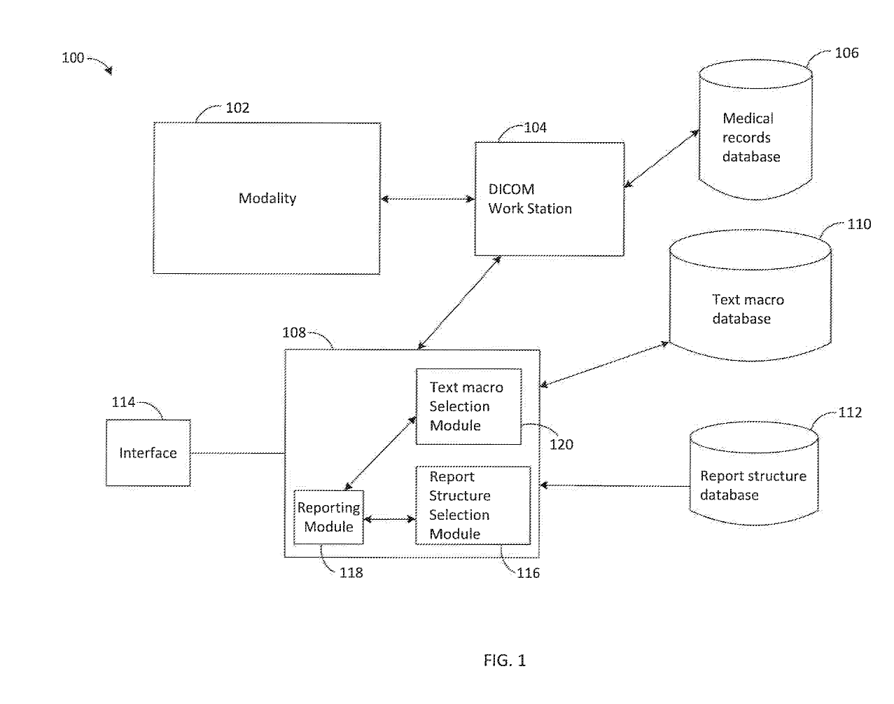

Reference is now made to FIG. 1, which illustrates elements of an exemplary embodiment of a medical report generation system 100. A modality 102, which may be any type of suitable medical device, is used for carrying out a medical procedure. Such a device may be for example Computed Radiography (CR), Computed Tomography (CT), Magnetic Resonance Imaging (MRI), Ultrasound (US), Positron Emission Tomography (PET), Digital Radiography (DX), Mammography (MG), X-Ray Angiography (XA), Nuclear Medicine (NM), or other device.

A DICOM workstation 104 may be connected to the modality 102. For example, it may be used to control the modality 102 for carrying out a medical procedure. DICOM workstation 104 may be further connected to a medical records database 106 for storing and retrieving medical records. For example, initial results, such as medical images, obtained from carrying out a medical procedure using modality 102 may be stored in the medical records database 106.

The medical report generation system 100 may be connected with the DICOM workstation 104 to send data thereto and receive data therefrom. Alternatively, medical report generation system 100 may be directly connected with the medical records database 106 to send data thereto and receive data therefrom.

The medical report generation system 100 may also be connected to a text macro database 110, which stores a plurality of text macros that are available to be used in sectional medical procedure reporting.

The medical report generation system 100 may also be connected to a report structure database 112, which stores a plurality of report structures to be used in sectional medical procedure reporting.

According to some exemplary embodiments, the medical report generation system 100 may have its own text macro database stored locally comprising a first set of available text macros. In addition, the medical report generation system 100 may be connected to an externally stored text macro database, such as text macro database 110, comprising a second set of available text macros.

Similarly, according to some exemplary embodiments, the medical report generation system 100 may have its own report structure database stored locally comprising a first set of report structures. In addition, the medical report generation system 100 may be connected to an externally stored report structure database, such as report structure database 112, comprising a second set of report structures.

A user interface 114 is provided to allow a user carrying out sectional reporting of a completed medical procedure to interact with the medical report generation system 100. A user may be a medical professional such as a doctor, dentist, physician, etc. The user interface 114 may include a display and input device. The input device may be any device that allows the user to send commands to the medical report generation system 100. The input device may be, but not limited to, a keyboard, a stylus, a mouse, a dictation device, a voice recognition system, or a motion detection sensor.

As discussed in more detail elsewhere, it should be understood that the medical report generation system 100 may be implemented in hardware or software or a combination of both. Specifically, the modules of medical report generation system 100 are preferably implemented in computer programs executing on programmable computers, each comprising at least one processor, a data storage system, at least one input device and at least one output device. Without limitation, the programmable computers may be a mainframe computer, server, personal computer, laptop, personal data assistant, cellular telephone, smartphone or tablet device. In an exemplary implementation, the medical report generation system 100 is implemented in software and installed on the hard drive of any suitable client workstation, such as client workstation 108, such that the client workstation 108 interoperates with the DICOM workstation 104 in a client-server configuration.

During reporting of a completed medical procedure (e.g. a radiology exam) for a given patient, the user will first view and analyze the outputs of the medical procedure. For example, outputs may be the medical images, performed procedure specific questionnaires, dose information or other type of procedure related attachments (e.g. voice notes, written comments) coming from Computed Radiography (CR), Computed Tomography (CT), Magnetic Resonance Imaging (MRI), Ultrasound (US), Positron Emission Tomography (PET), Digital Radiography (DX), Mammography (MG), X-Ray Angiography (XA), Nuclear Medicine (NM), and other modalities. The user will then record his or her observations of the medical procedure. For example, in field of radiology, it is typical for the user to analyze medical images of a radiology exam and to record her observations of the medical images. The outputs of the medical procedure and the user's observations are then recorded within a medical record. A medical report can be generated from the outputs and observations contained in the medical record. In other cases, the outputs and observations are stored within a medical record, for example in database. More medical reports can be generated at later time from the stored medical records if desired.

As medical reports for the medical record will be reviewed by other users later, it is desirable for the medical record to be organized and easy to read. The ease of use of the medical record depends on how the user initially enters observations for the medical procedure performed.

Sectional reporting is a method of reporting which allows a user to enter observations on the outputs of a medical procedure in an organized manner. The user separately enters observations for various aspects of the medical procedure. For example in radiology, a radiology procedure will include sections such as radiologist findings, reasons for the procedure, clinical indications, comparison studies, follow-up, image measurements, key images, procedure details, impressions, remarks, conclusions, recommendations and addendum. The separately entered observations are then separately maintained as report sections, which can then be used to create a medical record and/or generate a medical report.

An advantage of sectional reporting is that separately entered observations that are maintained as separate report sections can also be separately stored. This further allows for separate retrieval of the stored report sections. Unlike block form reporting where all the observations are entered as one continuous and contiguous data block that is difficult to parse, separate storage of the report sections allows for quick retrieval of only the report sections of interest. This allows for targeted analysis of medical records of completed medical procedures. In other cases, retrieval of separate report sections allows for data mining and analysis across numerous medical procedures. For example, it is possible to compare observed conclusions of a same type of medical procedure for many medical procedures of that type. Alternatively, it is possible to compare observed conclusions of several different types of medical procedures.

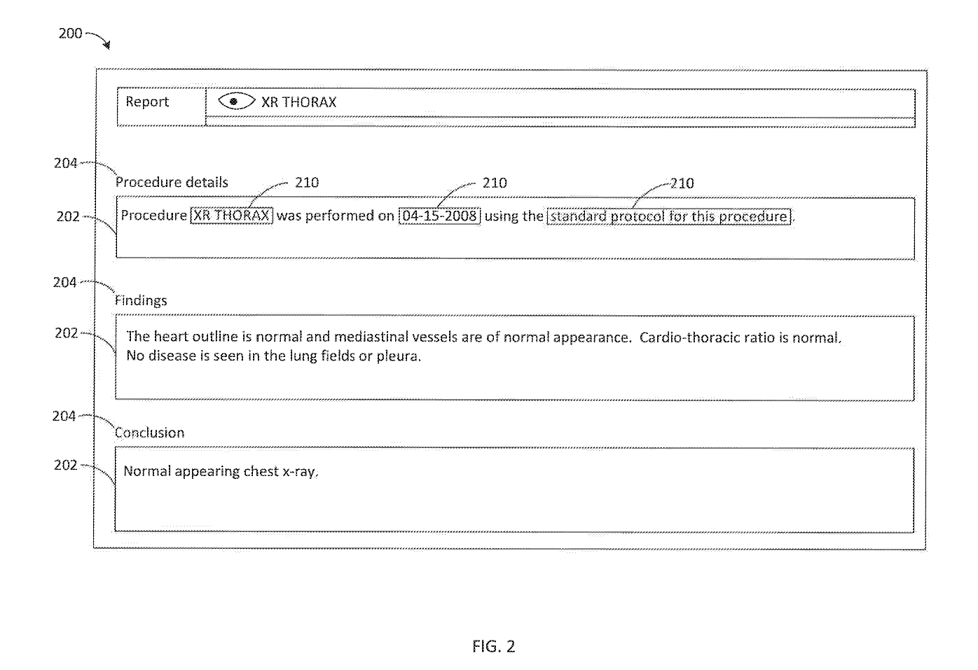

Referring to FIG. 2, therein illustrated is a schematic diagram of an exemplary input screen 200 displayed to a user on user interface 114 for entering observations for a medical procedure. For example, input screen 200 may have one or more observation entry boxes 202 for receiving entries of the user's observations. Each observation entry box 202 corresponds to a report section to be completed and maintained in a medical record. The observation entry boxes 202 may be associated with a type of report section to be maintained and may have an identifier 204 identifying the type of the report section.

For example, input screen 200 has identifiers 204 for report sections of the types “procedure details”, “findings” and “conclusions”. It will be understood that other types of report sections may be shown for completing the sectional reporting. The types of report sections shown on user interface 114 are based on a report structure selected for reporting the medical procedure. The report structure indicates one or more types of report section that are required to be entered for a complete medical record to be created. The report structure may further indicate types of report sections that are complementary in that they are not required for completing the reporting of the completed medical procedure.

The report structure that is selected depends on the properties of the completed medical procedure to be reported. Properties of the medical procedure should be understood as any properties associated with the medical procedure, including, but not limited to, the type of medical procedure, characteristics of the patient, the type of equipment used, and the medical worker who carried out the procedure.

For example, a specific type of medical procedure, such as a mammography, will require specific types of user observations and therefore specific types of report sections need to be completed. For example in the case of mammography, these report section types may be BI-RADS assessment or BI-RADS score. As a further example, a patient above or below a certain age or being of a specific ethnic background may require specific report section types to be entered. For example, in pediatrics, useful sections type may be ones for bone age or development milestones. This information may further influence the report structure that is selected for reporting the completed medical procedure.

In some exemplary embodiments, the medical report generation system 100 may have a report structure selection module 116 that accesses report structures database 112 in order to retrieve the report structure that is suitable for the medical procedure to be reported.

In some exemplary embodiments, multiple report structures may correspond to the medical record creation request. For example, for a medical procedure, it may be possible to create a short form record requiring only a few report section types to be completed, or it may be possible to create a long form record for completing a higher number of report sections of different types. In these embodiments, the report structure selection module 116 may present each of the corresponding report structures to the user via the user interface 114 to allow the user to select the most appropriate structure. Alternatively, the report structure selection module 116 may automatically select the report structure that is most relevant, or commonly used.

After retrieving a report structure, a reporting module 118 of the medical report generation system creates report sections for receiving observation entries. For example, report sections may be created and temporarily maintained in the system memory of the medical report generation system 100 during reporting. Report sections may be created for both required and non-required types of report section indicated by the selected report structure. For each created report section, an observation entry box 202 along with the identifier 204 identifying the type of report section may be displayed on the user interface 114. Created report sections may be populated by receiving entries made by the reporting user using the input device of the user interface 114. Populating of the created report sections may also be done by insertion of text blocks of text macros. Once all the types of report section indicated by the report structure as being required, are populated and the reporting user has indicated that reporting is complete, the populated report sections may be stored within a medical record and/or used to generate a medical report.

In some exemplary embodiments, after displaying the observation entry boxes 202 that correspond to the types of report sections indicated by the report structure, the reporting user may further manually modify which types of report sections are to be completed by selectively adding or removing types of report sections. This allows the user to manually customize the medical record that will be created. For example, this customization can allow a user to add an additional type of report section that is not part of the selected report structure, but which may be important for the given medical procedure or patient.

Storage of report sections after completion of the reporting of the medical procedure may occur locally on the medical report generation system 100, for example, when a medical report is to be immediately created from the observations entered by the user. Alternatively, the entered observations are stored within medical record in the medical records database 106 in an organized section reporting format to allow easy retrieval of the record or of individually stored report sections for generating a medical report at a later time.

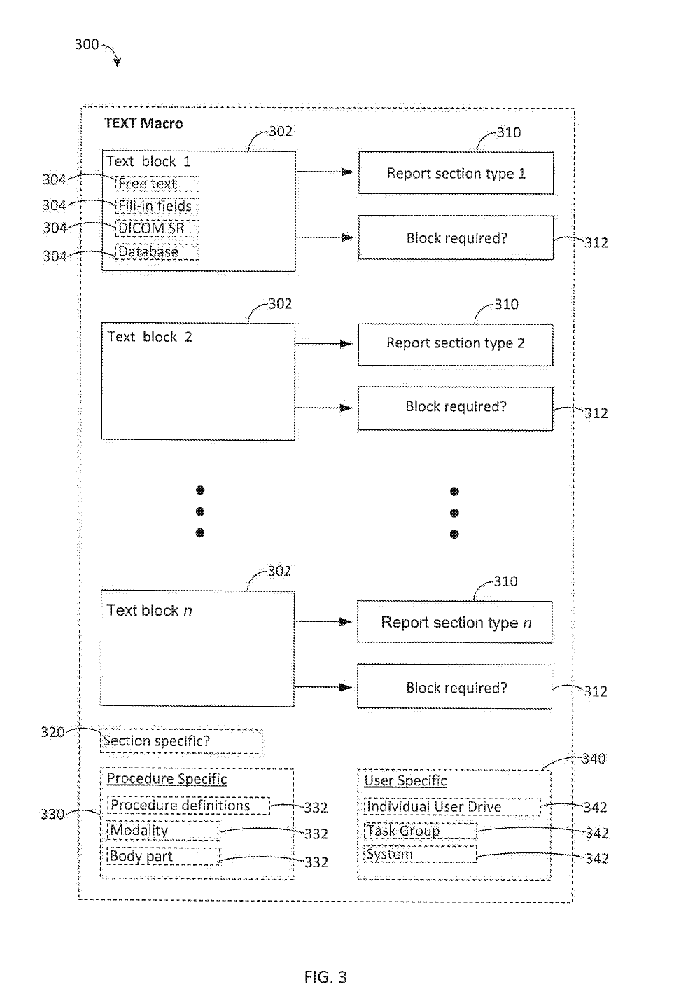

Referring now to FIG. 3, therein illustrated is a schematic diagram of an exemplary text macro 300 according to various embodiments that may be used to populate report sections of a selected report structure. A text macro 300 is a tool available to the user for entering observations for completing sectional reporting of a medical procedure.

Each text macro 300 comprises at least one text block 302, which may be identified by a text block number, for example 1 to n.

Each text block 302 has stored observation entry fields 304. The observation entry fields 304 are specific types of entries used to populate created report sections. Observation entry fields 304 may be of one or more types, such as plain text, fill-in fields, DICOM SR, and database field.

Plain text can be simply a string of text, such as “normal appearing chest x-ray”.

Fill-in field can indicate an observation entry sub-field within the observation entry box that must be completed by the user in order to complete the sectional reporting of the medical procedure. In some embodiments, a fill-in field may appear as a blank text box within an observation entry box 202. The user may then manually make an entry for the blank text box, which will then be saved within the created report section associated to the observation entry box 202. The fill-in field may contain a label to assist the user in knowing what type of entry to make, for example “right kidney length”.

Referring back to FIG. 2, for example, observation entry box 202 associated with the identifier 204 “Procedure details” contains three fill-in fields 210 that have been filled with the entries “XR THORAX”, “04-15-2008” and “standard protocol for this procedure”. Advantageously, the user interface 114 may be configured such that the user may quickly navigate through the fill-in fields of various observation entry boxes 202. For example, the user may scroll through the fill-in fields using a keyboard shortcut or using a voice command. Where the observation entry fields 304 of the text blocks 302 of the selected text macro 300 are already preconfigured with appropriate plain text and fill-in fields, the user need only navigate the fill-in fields and complete these fill-in fields in order to complete reporting of the medical report.

According to some exemplary embodiments, some of the fill-in fields may be set to be mandatory, in that, sectional reporting of the medical report may be completed only if all of the mandatory fill-in fields have received an appropriate entry.

According to some exemplary embodiments, some of the fill-in fields may be auto-filled based on certain preset rules. For example, a fill-in field of a text block may be linked to a set of entries that are determined based on some properties of the completed medical procedure being reported, such as patient age and gender. A different entry may be used to auto-fill the fill-in field based on different combinations of the properties. For example, when a text macro that has a fill-in field that is based on age and gender is used to populate a report section, two different entries may be entered into the fill-in field. If a female of childbearing age is the subject, the entry “Prior to the chest x-ray, the procedure was explained to the patient. The patient was also asked about pregnancy status and responded she was not pregnant.” may be entered. If a male patient was the subject, the entry “Prior to the chest x-ray, the procedure was explained to the patient” is entered instead without reference to pregnancy.

According to some exemplary embodiments, the possible values that may be entered into a fill-in field may be limited to a predefined set of values, For example, if a fill-in field is used to define a body part, the possible values may be limited to “left” or “right”. For example, fill-in field with a limited set of values may be presented as a drop-down menu within the observation entry box 202 on the user interface 114.

Referring back to FIG. 3, observation entry field 304 DICOM SR objects can indicate the content or results obtained for the medical procedure by the modality used to carry it out. For example, such objects may be measurement data or calculation results.

Database fields can indicate fields that are automatically populated based on data contained in various databases. For example database fields may be linked to any one of the following:
accession number (order level);
accession number;
study date (date on which the exam was performed);
order creation date;
number of images;
number of series;
patient: display name, first name, last name, middle name, prefix (Mr., Ms., Mrs.), age (days, weeks, months, years), sex (male/female), date of birth, ID;
technologist display name;
performing physician: display name, first name, last name, middle name;
ordering physician: display name, first name, last name, middle name, phone, title, address;
ordering department name;
ordering facility name;
report author: display name, first name, last name, middle name, title;
ordered procedure: code, name;
ordered procedure—body part;
ordered procedure—modality type;
report creation date and time;
reason for study;
study UID;
performed procedure step: code, comment, description, start time, end time, modality DICOM code, modality DICOM name;
exam room;
admission number.

According to some exemplary embodiments, the database field may be configured similarly to a fill-in field. For example, after the data from the database is retrieved and entered into the field, the reporting user can edit the entry. The user may also navigate across the various database fields of one or more observation entry boxes 202, for example using a voice command or keyboard shortcut.

According to some exemplary embodiments, if a database field is linked to a data entry in a database that is empty, the database field displayed in the observation entry box 202 of user interface 114 should also be left empty. Subsequently, when the report sections are saved within a medical record, the location of the database field within the corresponding report section is also left empty.

According to some exemplary embodiments, when a data entry in the database is updated, the database field linked to that data is also updated. However, when the user validates the medical record or medical report, for example, by signing off on the created medical record or report after completing sectional reporting, the database fields are frozen and no longer updated when the data in the database is updated. It is only by undoing the signing-off that the database fields can be automatically updated again.

According to some exemplary embodiments, when a database field is populated by the data of the database, this entry can be edited. However when the user subsequently edits the database field, the data from the database that is entered in the database field is changed to plain text and is no longer updated automatically.

According to some exemplary embodiments, each text block 302 may further have an associated report section type parameter 310, which indicates the type of report section for which the text block 302 is to be entered. For example, where a report section type parameter 310 is specified for a text block 302, the observation entry fields 304 of the text block 302 may only be used to populate a report section of the same type.

According to some exemplary embodiments, each text block 302 may further have an associated block required parameter 312, which indicates whether the text block 302 is required for completing the sectional reporting of the medical procedure. For example, no report can be signed off if the section block designed to indicate the availability of prior comparison studies is filled in, as this information is critical and mandatory, but a report can be signed off even though the section block designed to indicate the recommendation is left empty, as this information is always necessary for all procedures.

Text macro 300 further comprises text macro parameters which are used to determine the type of the text macro and, in some cases for determining the relevancy of the text macro 300 with respect to a medical procedure to be reported. For example, text macro 300 may comprise a “section specific” parameter 320, which indicates whether or not the text macro 302 is suitable for only populating a single report section. As described later, section-specific text macro may be used to “automatically” populate created report sections of a particular type without the user having to make text macro selection.

In some cases, the text macro 300 may be a free-text text macro. In such cases the text macro 300 only has one text block 302, which is not associated with any type of report section. Therefore, observation entry fields 304 of the text block 302 of the free-text text macro 300 may be used to populate a report section of any type. For example, often used text strings for reporting a medical procedure may be stored as a non-specific text macro 300, such as, “Patient's condition appears to be normal”.

For example, text macro 300 may comprise a “procedure specific” parameter set 330 having a plurality of sub-parameters 332. Procedure specific parameter set 330 indicates the type of medical procedure for which the text macro is relevant. For example, text-macro parameter set 330 can have sub-parameters 332 of “procedure definition=‘radiology’”; “modality=‘CT-scan’” and “body part=‘abdomen’” to indicate that the text macro is relevant for radiology, for CT-scans and for ‘abdomens’.

For example, text macro 300 may comprise a “user specific” parameter set 340 having a plurality of sub-parameters 342. User-specific parameter set 340 indicates the users or user groups for which the text macro is relevant. For example, text-macro parameter set 340 can have sub-parameters of “individual user=‘Dr. XYZ’”, “task group=‘radiology’” and “system=‘hospital ABC’” to indicate that the text macro is most relevant for Dr. XYZ, less particularly for radiology task group and even less so for hospital ABC.

Available text macros 300 are stored within the text macro database 110 which may be accessed by a text macro selection module 120 of the medical report generation system 110.

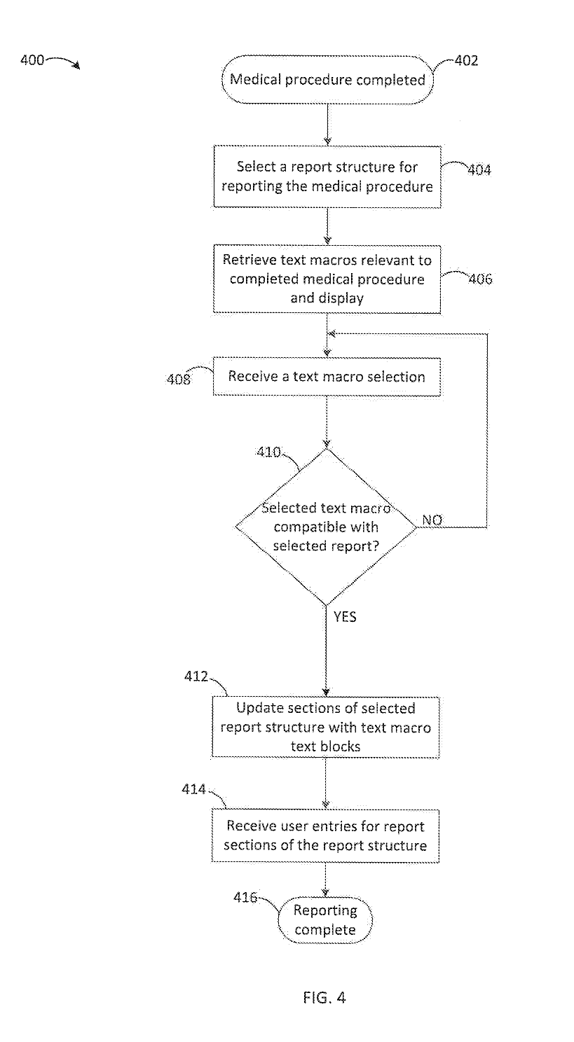

Referring to FIG. 4, therein illustrated is a schematic diagram of the steps 400 of a method for completing a medical record according to some exemplary embodiments. FIG. 4 illustrates example embodiments where the user makes a text macro selection in order to aid in the sectional reporting. However it should be understood that the exemplary embodiments described should not be limited to where the user must make a text macro selection. That is, it should be understood that according to some embodiments, a user can always complete sectional reporting of a medical procedure without making a text macro selection and instead complete the reporting by manually entering observations into the observation entry boxes 202. Such alternatives are intended to be covered by the current description.

At 402, a medical procedure performed on modality 102 is completed. For example, one or more medical images and one or more measurements taken during the medical procedure may be stored within a medical record in medical records database 106. A request for reporting the completed medical record and creating a medical record is received at the medical report generation system 100. The request will indicate at least some properties of the medical procedure, such as the type, date, time, modality and/or body part.

At step 404, a report structure that corresponds to the completed medical procedure indicated in the received medical record creation request is selected. Selection of the report structure may be performed by the report structure selection module 116 according to exemplary methods described above.

At step 406, text macros 300 relevant to the completed medical procedure are retrieved and titles of the text macros may be displayed on the user interface 114 to the user entering observations to complete the sectional reporting of the medical procedure. For example, retrieval of relevant text macros 300 may be performed by text selection module 120. For example, retrieval of relevant text macros 300 may be performed based on the text macro parameters and sub-parameters of the available text macros 300.

At step 408 a selection of a text macro 300 is received. For example, after the retrieved relevant text macros 300 are displayed as a list by their respective titles, the user can make a selection of a desired text macro by selecting, such as hovering over with the mouse over the displayed text macro title, highlighting the displayed text macro title, clicking the displayed text macro title or providing a voice command corresponding to the text macro 300.

At step 410, a determination is made of whether the text macro 300 selected at step 408 is compatible with the report structure selected at step 404. It will be appreciated that the selected report structure will indicate one or more types of report section that need to be completed and one or more complementary types of report sections. Likewise, the selected text macro 300 may also have one or more text blocks 302 that are required and that are associated with specific report section types 310. There may be an incompatibility between the selected report structure and the selected text macro if the required report section types 310 of the text macro 300 are not found within the set of types of report sections indicated by the report structure, and vice versa. In particular, there is an incompatibility where particular types indicated in the report section type parameters 310 associated with text blocks 302 of the selected text macro 300 are not found in the set indicated by selected report structure.

According to some embodiments, it may be determined that the selected text macro 300 is compatible with the selected report structure if all the types indicated in the report section type parameters 310 associated with the required text blocks 302 of the selected text macro 300 is a subset of only the required report section types indicated by the selected report structure. A text block 302 is required if its associated block required parameter 312 is set to “required”. Alternatively, it may be determined that the selected text macro is compatible with the selected report structure if all the types indicated in report section type parameters 310 associated with the required text blocks 302 of the selected text macro 300 is a subset of all the types of report sections indicated by the selected report structure, including both required report section types and complementary report section types.

If it is determined at 410 that the selected text macro 300 is not compatible with the selected report structure, the method may return to 408 to receive another text macro selection. For example, a message indicating that the selected text macro 300 is incompatible may be displayed on the user interface 114. Alternative text macros 300 may also be suggested on the user interface 114, such that the user can make another text macro selection and such that the method can return to 410 to further determine if the newly selected text macro is compatible with the selected report structure.

If it is determined at 410 that the selected text macro is compatible with the selected report structure, the method may continue to 412. At step 412, report sections created for the selected report structure are populated with the observation entry fields 304 of the text blocks 302 of the selected text macro 300.

For example, if the selected text macro 300 is free-text, then observation entry fields 304 of the one text block 302 of the selected text macro 300 may be inserted into the observation entry box 202 that is currently selected by the user on the user interface 114.

For example, if the selected text macro 300 is not free-text, the observation entry fields 304 of the text blocks 302, each being associated with report section types 310, are used to populate the created report sections having the same types.

At 414, entries that are made manually by the user are received. For example, a user may highlight an observation entry box 202 on the user interface 114, and make an entry or modification of the entry already made. For example, where an observation entry box 202 has not been inserted by an observation entry field 304 of a text block 302 of the selected text macro 300, the user may manually make an entry. Where the observation entry box 202 has been inserted with observation entry fields 304 of a text block 302 of the selected text macro 300 the user may modify that entry. Entry or modification may be performed by the user using any suitable input device of the user interface 114.

At 416, the sectional reporting of the medical procedure is completed and the temporarily created report sections may be stored as separate report sections within a medical record. For example, each report section may be stored to be associated with the report section type of the report section.

According to some exemplary embodiments, prior to completing the sectional reporting, a verification is made, for example by the reporting module 120, that all the report sections having the types indicated as being required by the selected report structure have been populated. According to some exemplary embodiments, a verification may also be made that the mandatory fill-in fields of observation entry field 304 of the text block 302 have been properly completed.

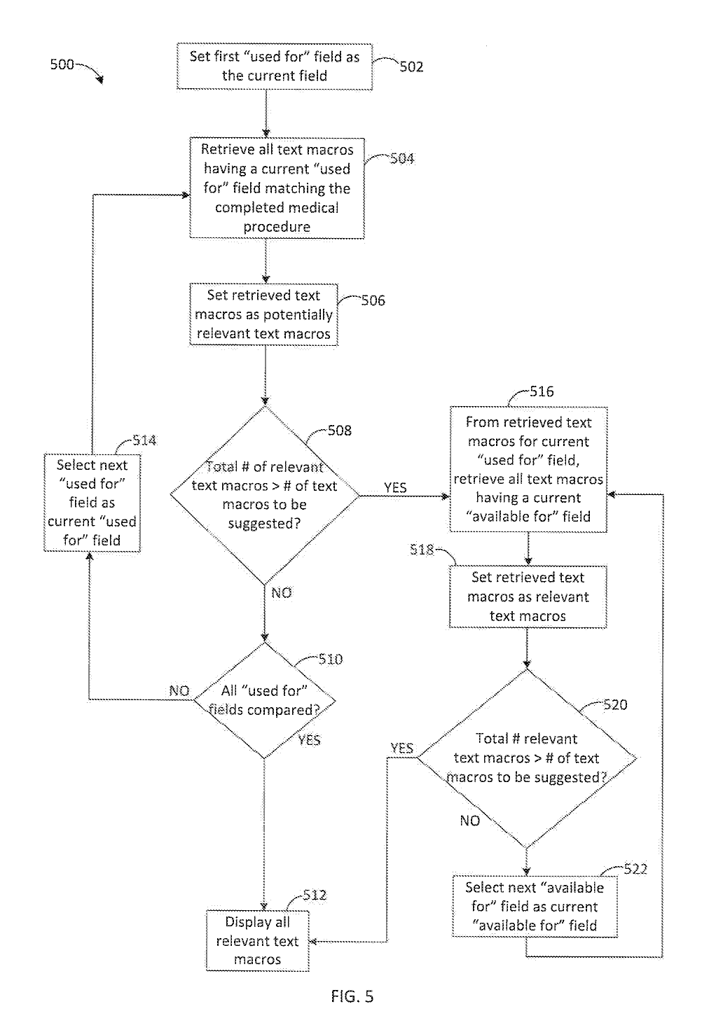

Referring now to FIG. 5, therein illustrated is a schematic diagram of a method 500 according to some exemplary embodiments for determining and retrieving text macros 300 that are relevant to the completed medical procedure to be reported.

At 502, a first procedure-specific property of the completed medical procedure that is to be reported is set as the current procedure-specific property. For example, where it is determined that the procedure definition is the most relevant property, procedure definition is set as the current procedure-specific property. For example, if the medical procedure to be reported has a procedure definition that is ‘radiology’, ‘radiology’ is set as the current procedure-specific property. Procedure specific property may also be understood as “used for” parameter of text macros 300 because it is used to determine whether a text macro 300 can be “used for” a specific type of medical procedure.

At 504, a search is made through the text macro database 110. The available text macros 300 stored in the text macro database 110 are checked to find all the text macros 300 of the available text macros 300 that have a procedure-specific parameter 332 that matches the current procedure-specific property. For example, if the current procedure-specific property is ‘radiology’, all text macros having the ‘radiology’ procedure definition sub-parameter 332 is retrieved at 504.

At 506, the text macros 300 retrieved at step 504 are set as potentially relevant text macros.

At 508, the total of the number of text macros 300 that are already identified as relevant and of those that are potentially relevant are compared with a predetermined number of relevant text macros 300 to be suggested. For example, it may be desired to only suggest a limited number of relevant text macros 300. Suggesting too many text macros 300 may overwhelm the user. Also, there may also not be enough space on the user interface 114 to display all the retrieved text macros.

If it is determined that the total number of text macros 300 that are relevant or potentially relevant does not exceed the predetermined number of relevant text macros 300 to be suggested, at 510 it is determined whether other procedure-specific properties of the medical procedure are available for finding more relevant text macros 300. If no more procedure-specific properties remain, then all text macros identified as relevant are suggested to the user at step 512, for example, by displaying them on the user interface 114.

If more procedure-specific properties remain, at step 514, the potentially relevant text macros retrieved at 504 are set as relevant text macros. Then the next most relevant procedure specific property, such as ‘modality’, may be selected as the current procedure specific property and the method returns to 504 to retrieve all text macros 300 having a sub-parameter 332 matching the newly set current procedure-specific property. It will be appreciated that text macros 300 having a sub-parameter matching procedure properties that are less specific to the completed medical procedure are also less relevant, and may be ordered after text macros 300 that have already been determined as being relevant.

Returning to step 508, if the total number of relevant text macros and potentially relevant text macros exceeds the number of relevant text macros 300 to be suggested, a further determination is made of relevancy of text macros from the text macros 300 identified as being potentially relevant based on another set of text macro sub-parameters, such as user-specific sub-parameters 342. Determination based on a second set of text macros sub-parameters is made to find which of the potentially relevant text macros are most relevant.

At 516, a second set of text macro sub-parameters is selected for the further determination of relevancy. The most relevant sub-parameter of the second set is set as the current sub-parameter. For example, where the second set of text macro sub-parameter is user-specific parameters, the current sub-parameter may be first set to ‘individual user’. User-specific parameters may also be understood as “available for” parameter of text macros because it is used to determine which users the text macro 300 can be made “available for.” From the potentially relevant text macros determined at step 506, all text macros 300 having a user-specific sub-parameter 332 matching the current user-specific property are retrieved at step 516.

At 518, all text macros retrieved at 516 is set as relevant text macros in addition to text macros previously identified as relevant text macros.

At 520, if the total number of relevant text macros after the retrieval at 518 is greater the number of text macros to be suggested, the relevant text macros are displayed at 512. For example, a number of most relevant text macros 300 equal to the number to be suggested may be displayed.

If the total number of relevant text macros does not exceed the number of text macros to be suggested, then at 522, the next most relevant sub-parameter of the second set of sub-parameters is selected as the current sub-parameter and at step 516 a further search is to identify from the potentially relevant text macros determined at step 506 all text macros 300 having a user-specific sub-parameter 332 matching the current user-specific property. Further searches according to the sub-parameter are made until the total number of relevant text macros is equal to or exceeds the number of text macros to be suggested, at which point the relevant text macros 300 are displayed at 512.

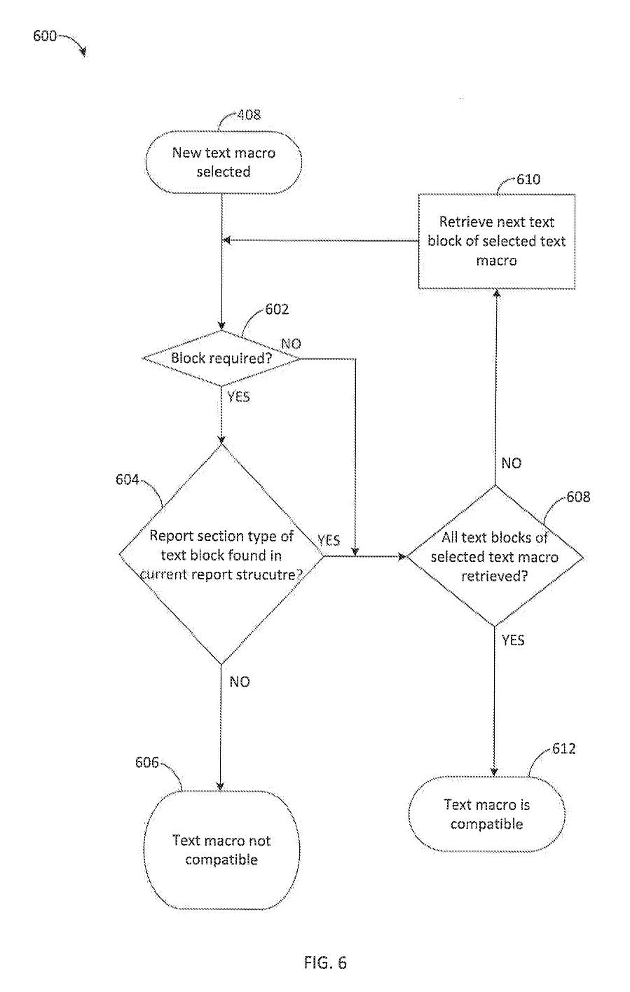

Referring now to FIG. 6, therein illustrated is a schematic diagram of a method 600 according to some exemplary embodiments for determining whether the selected text macro 300 is compatible with the selected report structure. For example, various steps of the method 600 may be performed as part of step 410 for determining whether the selected text macro 300 is compatible. For example, steps of method 600 may be performed by the text macro selection module 120 of the client workstation 108.

For example, after a text macro selection is received at step 408, it is determined at 602 whether a first text block 302 of the selected text macro 300 is required. For example, this may be done by verifying the block required parameter 310 of the text block 302. If it is determined at step 602 that the text block 302 is required, at 604, it is further identified whether a report section of the same type is indicated by the selected report structure. This determination may be made by comparing the report section type parameter 310 of the text block 302 against the types of report section indicated by the selected report structure.

If it is determined at 604 that a report section of the same type as the report section type parameter 310 of the text block 302 is not indicated by the selected report structure, the selected report structure is determined at 606 to be incompatible with the selected text macro 300.

If it is determined at 604 that a report section of the same type as the report section type parameter 310 of the text block 302 is indicated by the selected report structure, the method 600 proceeds to 608 to determine if all the text blocks 302 of the selected text macro have been verified.

If it is determined at step 602 that the text block 302 is not required or if it is determined at step 604 that a report section of the same type as the report section type parameter 310 of the text block 302 is indicated by the selected report structure, it is further determined at step 608 whether all the text blocks 302 of the selected text macro 300 have been verified. If not all the text macros have been verified, the next text block 302 of the selected text macro 300 is retrieved at step 610 and a determination is further made of whether a report section of the same type as the report section type parameter 310 of the next text block 302 is indicated by the selected report structure.

If it is determined at step 608 that all the text blocks 302 of the selected text macro 300 have been verified and since it was determined that the report section types of the same types as the report section type parameter 310 associated to each of the required text blocks 302 of the selected text macro 300 is indicated by the selected report structure, then the selected report structure is determined to be compatible with the selected text macro 300 at step 612.

It will be appreciated that according to some exemplary embodiments, if any one of the report section types 310 of the required text blocks 302 of the selected text macro 300 is not found in the selected report structure, the selected report structure will be found to be incompatible.

It will also be appreciated that according to some exemplary embodiments, if all the types included in the report section type parameters 310 associated to the required text blocks 302 are a subset of the available report section types indicated by the selected report structure, the selected report structure will be found to be compatible with the selected text macro 300.

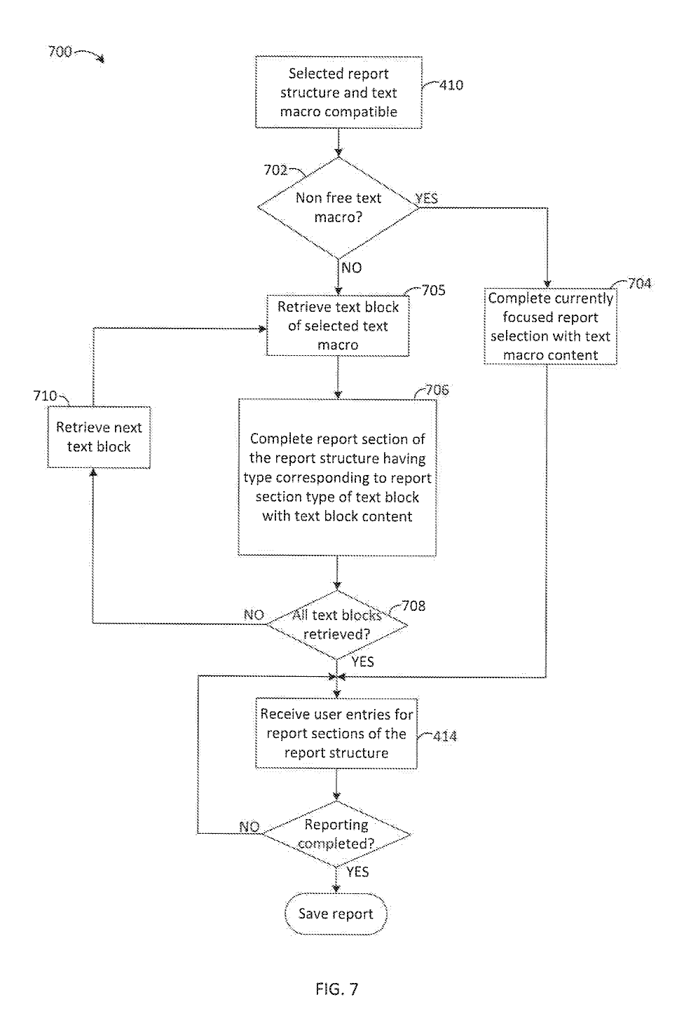

Referring now to FIG. 7, therein illustrated is a schematic diagram of a method 700 according to some exemplary embodiments for updating report sections created for the selected report structure with content from the selected text macro 300. For example, various steps of the method 700 may be performed as part of step 412 for updating report sections of selected report structure with content of the selected text macro. For example, steps of method 700 may be performed by the reporting module 118 of the medical report generation system 100.

For example, after having selected a report structure at 404 and received a text macro selection at 408, and having determined that the two are compatible at 410, a first determination may be made at 702 of whether the selected text macro 300 is a free-text text macro.

Since a free-text macro may be used to update any report section irrespective of the report section type, a way is provided to determine where the content of the free-text text macro 300 specific should be inserted. According to some exemplary embodiments, content of the free-text text macro 300 may be used to update at 704 the created report section associated with the observation entry box 202 that is currently focused, for example either selected or highlighted by the user on the user interface 114.

After updating the report section associated with the currently focused observation entry box 202, the method proceeds to 414 to receive user entries for report sections yet to be completed or to update already populated report sections. However, it will be appreciated that more than one free-text text macro may be sequentially selected for the same selected report structure to populate more than one created report section, A free-text text macro may also be selected for completing the reporting of a medical procedure in addition to selection of a text macro 300 that has text blocks 302 associated with specific report section types.

If it is determined at 702 that the selected text macro 300 contains text blocks 302 that have defined report section type parameter 310, the next text block 302 is retrieved at 705. If no text blocks 302 have yet been retrieved, the first text block 302 is retrieved.

At 706, the created report section of the type matching the type indicated in the report section type parameter 310 associated to the text block 302 retrieved at step 705 is populated by entering the observation entry field 304 of that text block 302.

At 708, it is determined whether all the text blocks 302 of the selected text macro 300 have been retrieved and the observation entry fields 304 of the text blocks 302 have been used to populate a created report sections of a matching type. If all the text blocks 302 have been retrieved, then updating of the sections is complete and the method proceeds to step 414 to receive user entries into the observation entry boxes 202 for further populating or updating of report sections created for the selected report structure.

If all the text blocks 302 have not been retrieved, the next text block 302 is retrieved at 710 for updating the report sections created for the selected report structure. Retrieval of text blocks 302 is repeated until all the text blocks 302 have been retrieved and the fields of the text blocks have been entered into corresponding observation entry boxes 202.

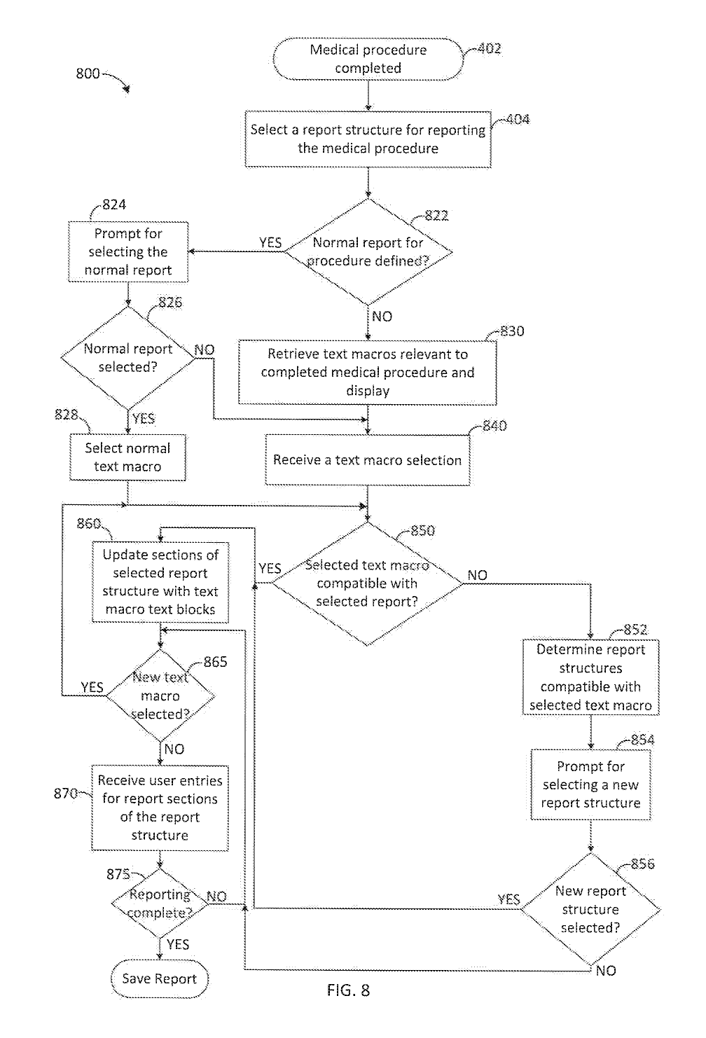

Referring to FIG. 8, therein illustrated is a schematic diagram of a method 800 for completing a medical record according to some exemplary embodiments. The method 800 is similar to the method 400 but is more detailed in that it shows in one aspect the steps for selecting a normal report. It also shows in another aspect, steps for selecting a report structure when the selected text macro 300 is not compatible with the selected report structure. However it will be appreciated that both additional aspects need not necessarily be included together in exemplary embodiments. For example some exemplary embodiments may only have the additional steps for selecting a normal report while other exemplary embodiments may only have the additional steps for selecting a new report structure.

At 402, a medical procedure performed on modality 102 is completed. For example, one or more medical images and one or more measurements taken during the medical procedure may be stored within a medical record in medical records database 106.

At step 404, a report structure that corresponds to the received medical record creation request is selected. Selection of the report structure may be performed by the report structure selection module 116 according to exemplary methods described above.

According to embodiments where a normal report may be selected, at step 822 it is determined whether a normal report is defined for the completed medical procedure. A normal report may represent a report, which may include a text macro and/or a report structure, that is most often used, or that fits a particular sectional reporting standard. For example, normal reports may be stored in a normal report database or locally stored within the text selection module 114. For example, a normal report may indicate a unique report that is standard for the specific medical procedure that is completed. The normal report may indicate a normal text macro to be selected. The normal report may also indicate a normal report structure to be selected with the completed medical procedure.

According to some exemplary embodiments, a normal report is presented for selection by the user in order to report that the results of the medical procedure are normal. As it will be appreciated, a normal report is particularly useful as a time-saving tool because for many types of medical procedure the results will in a majority of cases be normal. As a result, in many instances the user will be entering the same observations in the medical record to indicate that the results are normal and will therefore benefit from the normal report as being a quickly accessible tool for entering these observations. Furthermore, since the same observations are to be entered each time the results are normal, only one normal report is made available for selection by the user for a particular completed medical procedure to be reported. Therefore, when defining text macro to be a normal report, a verification may be made to ensure that another normal report has not already been defined that would cause a conflict.

For example, in some exemplary embodiments, only one normal report is defined for a particular procedure type such that only that normal report can be selected. However, in other exemplary embodiments, more than one normal report may be defined for a particular procedure type but each normal report defined is associated with a unique rank with respect to other normal reports defined for the same procedure type. For example, normal reports defined for the same procedure type may be each provided with unique user-level metadata. The normal report having the highest ranked user-level metadata is retrieved and made available for selection by the user.

For example, a first normal report can be defined for a particular medical procedure type and associated with the particular user account of the user, a second normal report can be defined for the same medical procedure type and associated with a task assignment group to which the user account belongs to, and a third normal report can be defined and associated with the system that includes the task assignment group. In such a case, the normal report being associated with the user account is retrieved for selection by the user because it is the highest ranked and the most specific. If no normal report is defined for the user account, then normal report being defined for the next most specific user level is selected for retrieval.

According to some exemplary embodiments, where a normal report is defined, a prompt may be displayed on user interface 114 at 824 to prompt the reporting user to decide whether the normal report should be selected or not. Alternatively, normal report may be made available for selection on user interface 114. For example, normal report may be displayed separately from other relevant text macros that are retrieved and made available for selection on the user interface 114.

At step 826, it is determined whether the normal report has been selected. If the normal report is not selected, the method proceeds to 830 and the text macros that are relevant to the completed medical procedure are displayed and selection of a text macro made by the user is received at step 840. At step 826, if the normal report is selected, then the normal text macro indicated in the normal report is selected at step 828. According to some embodiments the normal report also includes a normal report structure and the normal report structure is also selected.

According to some exemplary embodiments, where a normal report is defined, the normal report may be automatically selected. For example, the text macro indicated by the normal report may be automatically selected. As it will be appreciated, when the normal report represents a report that is often used or that is required for a particular sectional reporting structure, automatic selection of the normal report allows further economy in the amount of time required from the user to complete reporting of the medical procedure.

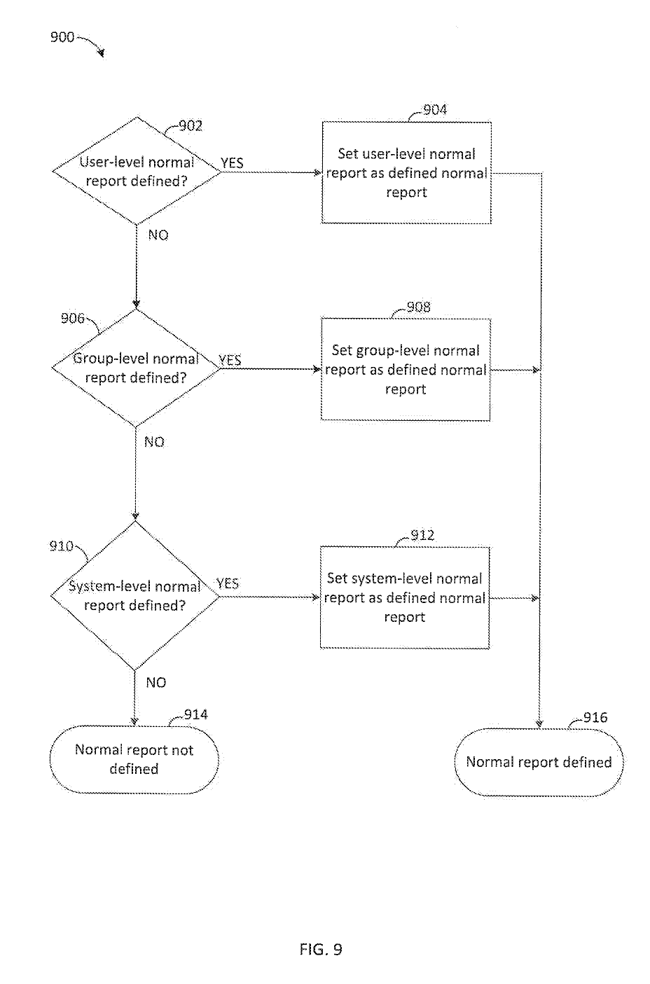

Referring now to FIG. 9, therein illustrated is a schematic diagram of the steps of an exemplary method 900 for selecting a normal report based on the specificity of the user-level property. For example, various steps of method 900 may be performed as part of step 822 for determining whether a normal report is defined for the completed medical procedure.

For example, at 902 it is determined whether a normal report having user-specific property that matches the current user or user group is defined. If the user-specific property matches, at 904 that normal report is defined as the normal report and it is determined at 916 that a normal report is defined.

If such a normal report is not defined, at 906, it is determined whether a normal report having a group-specific property that matches the group defined for the current user or user group is defined. For example, a user may not have any normal reports defined specifically for his or her user account such that no normal report having user-specific property that matches the user account will be found at 902. However, since the user account of the user may be associated with a specific group, such as all users of the internal medicine department, a normal report having a matching group-specific property may be found at 906.

If a normal report having a matching group-specific property is found at 906, at step 908 the group-level normal report is defined as the normal report for the completed medical procedure and it is determined at 916 that a normal report is defined.

If no normal report having a matching group-specific property is defined, at step 910, it is determined whether a normal report having a system-specific property that matches the system defined for the current user or user is defined. If such a normal report is found, at 912 the system-specific normal report is defined as the normal report for the completed medical procedure and it is determined at 916 that a normal report is defined.

If no system-specific property is defined, and the system-specific property is the least specific property, it will be determined at 914 that no normal report is defined for the completed medical procedure to be selected. As will be appreciated, the determination of the normal report is based upon the rank of the unique user-level metadata for each of the normal report, with the highest-ranked user-level specific normal report being defined as the normal report for the completed medical procedure.

Returning to FIG. 8, after either selecting the text macro of normal report at step 828, or selecting a text macro from the retrieved relevant text macros at step 840, a determination is made at step 850 of whether text macro selected at either step 828 or 840 is compatible with the currently selected result structure. For example, determination of whether the selected text macro is compatible with the selected report structure may be made according to the steps described in method 600 shown in FIG. 6. For example selected text macro can be determined to be compatible if all the required text blocks 302 is a subset of the report section types indicated by the selected report structure.

If it is determined at 850 that the selected text macro is compatible with the selected report structure, the method continues to 860. At 860, report sections are populated by the observation entry fields 304 of the text blocks 302 being associated with a matching report section type. For example populating of report sections may be performed similarly to the updating at 412 of FIG. 4.

At 865, it is determined whether the user has selected another text macro 300. For example, after relevant text macros are retrieved and displayed and a selection of a text macro 300 is made from the retrieved relevant text macros 300, the relevant text macros may continue to be displayed such that an alternate selection of a text macro 300 may be made. Where another text macro has been selected at 865, the method returns to 850 to determine whether the newly selected text macro is compatible with the currently selected text macro. For example, determination of whether the user has selected another text macro 300 may be made periodically until the reporting of the medical procedure is completed.

If another text macro is not selected at 865, user entries are received at 870. For example, receiving of user entries may be performed in a similar manner to the receiving of user entries at 414.

At 875, it is determined whether the reporting of the medical procedure is completed. For example, completion of reporting may be indicated by the user selecting a save function. If the report has not yet been completed, the method returns to 865 to monitor for selection of new text macro 302 and for receiving manually entered observation entries.

According to some exemplary embodiments where a further selection of a report structure can be made, if it is determined at 850 that the selected text macro is not compatible with the selected report structure, at 852 a further search is made for determining other report structures that are compatible with the currently selected text macro 300. For example, a scan of the report structure database 112 may be carried out, for example by the report structure selection module 116 to identify additional report structures that are compatible with the selected text macro. For example, a report structure may be determined to be compatible if the types of report sections indicated by that report structure includes all of the types of report sections type parameters 310 associated to the text blocks 302 that are required within the selected text macro 300.

At step 854, the report structures retrieved at step 852 that are compatible with the selected text macro 300 are presented to the user, for example, via user interface 114. The user may further be prompted to make a selection of another report structure.

At 856, it is determined whether the user has made a selection from the report structures retrieved at 852. If another report structure has been selected at 856, report sections are created for each of the types of report sections indicated by the selected report structure. Then at 860, report sections created for the newly selected report structure are populated by the observation entry fields 304 of the text blocks 302 being associated with matching report section types of the selected text macro 300.

If another report structure has not been selected, a warning message is presented, for example, via the user interface 114 that the selected text macro cannot be applied to the currently selected report structure. At step 865, it is further monitored to determine whether another text macro 300 has been selected. If no text macro 300 is selected, it will be appreciated that the reporting may still be completed by having the user manually populate each of the report sections created for the selected report structure at step 870.

According to some embodiments, to further simplify the task of a user and to shorten the time required for completing the reporting, section-specific text macros may be used to update report sections of a selected report structure. A section-specific text macro refers to a particular type of text macro that only has one text block 302 that is associated with a particular report section type. For example, each text macro may further comprise a section specific meta-data 320 to indicate whether or not the text macro is section-specific. Accordingly, the section-specific text macro 300 is used to only populate one created report section that has a matching report section type.

For example, created report sections can be updated with these text macros even prior to the user making a selection of a text macro 300 for reporting the completed medical procedure.

For example, when analyzing a plurality of available text macros in order to retrieve those text macros relevant to the completed medical procedure, for example at 406 of FIG. 4 or 830 of FIG. 8, the text macro selection module 110 can also determine whether each available text macro is a section-specific text macro. This determination may be made by checking the section specific parameter 320 of the text macro 300. When a section-specific text macro is found, a further check is made to determine whether the report section type parameter 310 of the one text block 302 of the text macro 300 matches any one of the report section types indicated by the selected report structure. A check is also made to determine whether the section-specific text macro is not restricted to a particular medical procedure type and is applicable to all medical procedure types.

For example, each of the procedure-specific metadata 332 can be undefined to indicate that the text macro 300 can be applied for any medical procedure irrespective of the context of use (procedure definition, modality or body part). Alternatively, the text macro may further comprise a ‘context defined’ metadata to indicate whether the text macro is defined for a specific context of use or not. It will be appreciated that when the text macro 300 is not defined for a specific medical procedure type or medical procedure context, the text macro can be safely used to update a report section of the medical record without erroneously being used for a type of medical procedure for which it was not intended.

Accordingly, when a section-specific text macro is found that has a text block 302 associated with a report section type parameter 310 that matches one of the types of report sections indicated for the selected report structure, and that the text macro 300 is applicable to all medical procedure type, in some embodiments the report section of the medical report having a matching type is immediately updated with the observation entry field 304 of the text block 302.

In some embodiments, where the medical record to be stored has not yet been created, a medical record comprising at least the report section to be populated by the text block 302 of the matching section-specific text macro is created prior to updating the report section of the medical record. For example, information such as date and time of the medical procedure, patient identification information, medical practitioner who conducted the procedure are types of report sections that are consistently uniform irrespective of the type of medical procedure to be reported. It will be appreciated that for a user reporting the completed medical procedure, the retrieval of section-specific text macros and updating report sections with the text blocks of the section-specific text macros will appear as if the observation entry boxes 202 have been automatically filled.

In some exemplary embodiments, retrieval of section-specific text macros may be done in a step that is separate from the retrieval of text macros. For example, section-specific text macros may be separately stored from the available text macros for user selection in order to be easily retrievable. At any point prior to receiving a selection of a text macro 300 from the retrieved relevant text macros, a search of the section-specific text macros can be made to identify those section-specific text macros that can be used for “pre-filling” report sections of the medical record. Section-specific text macros are particular useful for quickly filling report section types that are present for different types of medical procedures and where the observation entry will be consistently the same even though the medical procedures are different.

In some exemplary embodiments, it is possible to conduct multi-procedural reporting. For example a user may simultaneously view and report on trauma images, chest x-rays and extremities x-rays for the same patient although the patient had to undergo three separate medical procedures, for example conducted on different medical modalities, to obtain the medical images being viewed. In such cases multiple medical procedures may be simultaneously reported by a user, but the request for creating a medical record will be for at least a first completed medical procedure and a second medical procedure. Such a request will further include at least one medical procedure property pertaining to the first medical procedure and at least one medical procedure property pertaining to the second medical procedure. Exemplary embodiments for multi-procedural reporting presented herein are described with respect to a first medical procedure to be reported and a second medical procedure to be reported, however it will be understood that multi-procedural reporting may be adapted for simultaneously reporting of any number of medical procedures.

A first report structure is selected for the first medical procedure to be reported. This selection may be based on the at least one medical procedure property of the first medical procedure. The selected first report structure will further indicate a first set of types of report section for completing the reporting of the first medical procedure.

Similarly, a second report structure is selected for the second medical procedure to be reported. This second selection may be based on the at least one medical procedure property of the second medical procedure. The selected second report structure will further indicate a second set of types of report sections that are required for completing the reporting of the second medical procedure.

It will be appreciated that the first medical procedure may be of a different type than the second medical procedure and therefore the selected first report structure and the selected second report structure can differ. As a result, the first set of types of report sections and the second set of types of report sections may also differ. However, some of the types of report sections of the first set may overlap with some of the types of report section of the second set.

After selecting the first report structure and the second report structure, report sections are created for each of the types indicated by the first set of the selected first report structure and by the second set of the selected second report structure. For example, report sections may be created and temporarily maintained in the system memory of the medical report generation system 100 during reporting. Each created report section is associated with either the first report structure, the second report structure, or both such that the report sections can be stored within separate medical records once reporting is completed. It will be understood that although the user is simultaneously reporting on the first and second medical procedures, the created report sections associated with each of the selected report structures for the medical procedures may be maintained separately. In this way, separate medical records can be created for each of the first and second medical procedures once reporting is completed.

According to some exemplary embodiments, a composite user interface may be presented to the user on display 114 during multi-procedure reporting. For example, where a type of report section is required by both the first and second report structures, a single observation entry box 202 can be presented on the display 114. It will be appreciated that this provides a saving of time for the user because the same entry will not have to be repeated for each of the medical procedures to be reported.

A first set of text macros that are relevant to the first medical procedure is retrieved. For example, retrieval of relevant text macros may be carried out according to the steps described in FIG. 5.

Similarly, a second set of text macros that are relevant to the second medical procedure is retrieved. For example, retrieval of the second set of relevant text macros may also be carried out according to the steps described in FIG. 5.

According to some exemplary embodiments, retrieved text macros of the first set and retrieved text macros of the second set are further ordered prior to being displayed for selected by the user. For example, retrieved relevant text macros of the first and second sets can be ordered according to which of the medical procedures was most recently completed. The retrieved text macros that are relevant to the most recent medical procedure can then be given a higher order.

In some embodiments, retrieved text macros may be ordered to alternate between the first set of relevant text macros and the second set of relevant text macros with the text macros of the set being relevant to the most recent medical procedure being given a higher order. For example, if the second procedure is more recent, relevant text macros of both sets can be ordered according to:
First text macro for procedure 2;
First text macro for procedure 1;
Second text macro for procedure 2;
Second text macro for procedure 1;
Third text macro for procedure 2;
Third text macro for procedure 1.
   The retrieved text macros from both the first set and the second set are then displayed on user interface 114 according to the established order for selection by the user. It will be appreciated that ordering of the relevant text macros for the multiple medical procedures allows the most relevant text macros to be given primacy when presented to the user, which further allows the user to quickly access the most relevant text macros.

A first text macro selection request can be received which indicates a user-selected text macro which has been selected from among the text macros relevant to the first medical procedure. A determination is made as to whether the first selected text macro is compatible with the selected first report structure for the first medical procedure. Where the first selected text macro is compatible, each of the report sections created for the first report structure are updated with the corresponding text blocks of the first selected text macro.

Similarly a second text macro selection request can be received which indicates a text macro that the user has selected from among the text macros relevant to the second medical procedure. A determination is made for whether the second selected text macro is compatible with the selected second report structure for the second medical procedure. Where the second selected text macro is compatible, each of the report sections created for the second report structure are updated with the corresponding text blocks of the second selected text macro.

According to some exemplary embodiments, multi-procedure reporting may be conducted according to a “repeat per procedure” setting. According to such settings, one report section is created for each type of report sections indicated by each of the selected report structure. Therefore, two or more report sections having the same type may be created, with one being associated with a first report structure and another being associated with a second report structure.

According to some other exemplary embodiments, multi-procedure reporting may be conducted without a “repeat per procedure” setting. Accordingly, where a type of report section is indicated by multiple selected report structures, only one report section is created for and shared by all of the selected report structures. For example, this one report section can be associated with each of the selected report structures that have this report section type. When a text macro selection is made for one report structure, and the shared report section is updated, that update will be applied for all the selected report structures associated to the report section. Furthermore, if the user inputs an entry for the shared report section, for example using an observation entry box 202, that entry will be applied for all the selected report structures associated to the report section. It will be appreciated that this provides a saving of time for the user because the same entry will not have to be repeated for each of the medical procedures to be reported.

By contrast, where the “repeat per procedure” setting is applied, selecting a text macro that is relevant for one medical procedure will only result in the updating of report sections associated to the report structure selected for that medical procedure and will not result in the updating of report sections associated to any other selected report structures. It will be appreciated that this setting may be useful where the medical procedures to be reported are not closely related and different entries may be required for the same type of report sections of different report structures when reporting for more than one medical procedures.

Since each created report section is associated with at least one report structure, it is possible to flexibly save the populated report sections within one or more medical records. For example, it is possible to create one medical record for each of the medical report structures selected and used during sectional reporting. For example, all report section associated with the first report structure may be saved within a first medical record and all the report section associated with the second report structure may be saved within a second medical record that is separate from the first medical record. Accordingly, where “repeat per procedure” setting is not being used, a report section may be associated with more than one report structure. In such a case, a shared report section may be saved more than once within more than one medical record.

According to some exemplary embodiments, it is also possible to create a single medical record for the multi-procedural reporting by saving all the populated report sections within a single medical record.

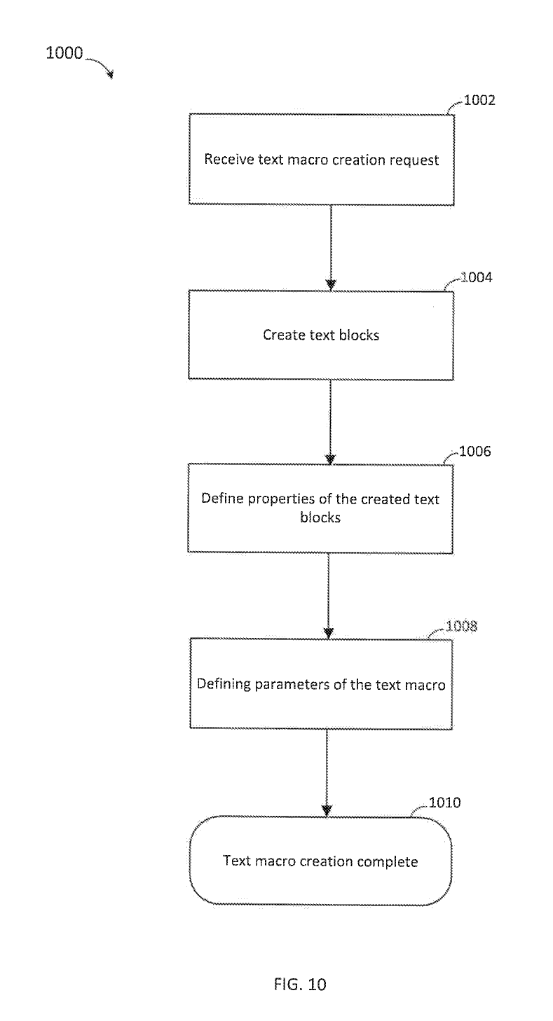

Referring now to FIG. 10, therein illustrated is a schematic diagram of a method 1000 for creating a text macro according to various exemplary embodiments. For example, the steps of method 1000 may be carried out by the text macro selection module 120 of the medical report generation system 100.

At 1002, a request for creating a new text macro is received. For example, the user may enter a command via the user interface 114, for example by selecting a creation option, keyboard shortcut, or voice command, for creating a new text macro. A new text macro is then created. For example, the user can create a new text macro that spans part of, or an entire report structure.

For example, the user can also create a new text macro as a report spanning a single section only.

For example, the user can also create a text macro that is a block of text, which can then be used as a free-text text macro.

At 1004, at least one text block 302 is created to be included in the newly created text macro 300.

For example, the user can create new text blocks from scratch by individually creating text blocks 302 and creating the observation entry fields 304 for each text block 302 by manually creating the entries through the user interface 114. The user can select the content for each text block, such as inserting free text, fill-in fields, database fields, or DICOM SR object.

According to some embodiments, text blocks for the text macro can be created from already existing content. For example, text blocks for the new text macro can be created from a report in progress or a completed report. Report in progress herein refers to report sections that are temporarily maintained while sectional reporting of a completed medical procedure is ongoing. For example, as a user is reporting a medical procedure, he or she may also choose to use the entries made during reporting for creating the new text macro.

Completed report herein refers to a saved medical record or medical report after sectional reporting has been completed. When creating text blocks from already existing content, a text block may be created from one of the populated report sections by storing the content of the populated report section in the new text block of the new text macro. For example, a text block may be created for each of the populated report sections of the report in progress or completed report. Alternatively, text blocks may be created for only some of the populated report sections. For example, the user may select which populated report sections are to be used for creating text blocks of the new text macro.

It is possible to import text macros 300 from an external source, such as an external storage device, a 3rd party application, including legacy systems, or from a previous system. Any mismatches between the text macro 300 of the external and the configuration of the medical report generation system 100 can be resolved during the importing process.

At step 1006, one or more properties of each of the created text blocks can be defined. For example, the report section type parameter 310 can be defined for each of the created text blocks. The block required parameter 312 can also be defined for each of the created text blocks. Properties of the created text blocks can be defined by the user using the user interface 114, for example, by selecting various checkboxes for each of the created text blocks.

According to some embodiments, properties may be defined for a text block created from existing content that matches the report section from which it was created. For example, if a text block is created from a populated report section, the report section type parameter 310 may be defined to be the type of that populated report section. Moreover, if that report section is required, for example as indicated by the selected report structure, the text block created from that report section is also defined as being required in the block required parameter 312.

At step 1008, one or more parameters may be defined for the newly created text macro. For example, whether the text macro is a section-specific text macro according to section-specific parameter 320 can be defined.

One or more procedure-specific parameters 330 may be defined for the new text macro. For example the procedure-specific parameter 330 may be defined from the specific (procedure definition) to more general (All Procedures), in the following order: 1. Procedure Definition; 2. Modality type+Body Part; 3. Modality type; 4, Body Part. The procedure-specific parameters 330 may be defined by receiving a selection for the procedure-specific parameters, for example, made by the user through the user interface 114. The selection is then stored as procedure-specific metadata 330 for the new text macro.

The user-specific parameter 340 may be defined for the new text macro. The user-specific parameter can be set by linking it to: one or more task assignment groups, or be available for everybody (System). The order applies from specific (User) to more general (System) in the setup. The user-specific parameters may be defined by receiving a selection for the user-specific parameters, for example, made by the user through the user interface 114. The selection is then stored as metadata for the new text macro.

Where the new text macro is created from a report in progress and a text macro has been selected during reporting of the report in progress, the parameters of the new text macro may be defined to be the same as the selected text macro.

Entries for the new text macro may also be formatted. This may be equivalent to the normal text editing. For example the following functionality may be available:
text formatting: bold, italic and underline;
uppercase and lowercase;
align left, center;
copy, cut, paste the results via right mouse click actions or via the keyboard shortcuts;
bullets, numbering;
spellchecking available in the text macro, equivalent to the normal text editing; and
decrease indent and increase indent.

The user may further indicate that a new text macro is to be used as normal report. In such a case, the user further indicates a specific medical procedure type to which the new normal report is to be linked. One normal report may be linked to multiple procedure types. However, where more than one normal report is linked to one medical procedure type, each normal report linked to that medical procedure type must have a uniquely defined user-level metadata. Accordingly, when creating a normal report, the user may further define a user-level for the normal report.

If a user is reporting multiple procedures, normal report generation is not available unless the multi-procedure contains the same performed procedure.

While the various exemplary embodiments of the medical report generation system 100 have been described in the context of medical image management in order to provide an application-specific illustration, it should be understood that the medical report generation system 100 could also be adapted to any other type of image or document display system.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A method for completing a medical record comprising:
receiving at a first client workstation a medical record creation request for at least a first completed medical procedure, the request indicating at least one medical procedure property of the first completed medical procedure;
retrieving one or more first relevant text macros, each of the text macros comprising at least one text block;
selecting a first report structure based on the at least one medical procedure property of the first completed medical procedure, the first report structure indicating a first set of one or more types of report sections for completing the medical record;
receiving a first text macro selection request comprising a first selected text macro selected from the retrieved first relevant text macros; and
determining whether the selected first text macro is compatible with the selected first report structure based on the types of report sections for the first selected report structure and the at least one text block of the selected first text macro.

2. The method of claim 1, wherein retrieving the one or more first relevant text macros comprises determining whether a normal report is available for the medical procedure type, the normal report indicating a normal text macro to be selected.

3. The method of claim 2, further comprising if a normal report is available, selecting the normal text macro as the first selected text macro.

4. The method of claim 3, wherein determining whether a normal report is available comprises:
retrieving one or more normal reports that are available for the medical procedure, each normal report comprising a ranked user-level property; and
selecting as the available normal report the retrieved normal report having the highest ranked user-level property.

5. The method of claim 1, wherein the one or more relevant text macros are determined according to matching of one or more procedure-specific properties of the medical procedure with one or more procedure-specific properties metadata of each of a plurality of available text macros.

6. The method of claim 5, wherein the one or more relevant text macros are further determined according to one or more user-level metadata of each of the matching available text macros.

7. The method of claim 5, wherein the procedure-specific properties are selected from: procedure type, modality type, body part, or a combination thereof.

8. The method of claim 6, wherein the one or more user-specific properties are selected from: user identification, group identification or system identification.

9. The method of claim 6, wherein the one or more procedure-specific properties and the user-level metadata of any one of the text macros indicates a relevancy of the text macro, the method further comprising:
displaying the retrieved first relevant text macros by order of relevancy of each of the retrieved first relevant text macros.

10. The method of claim 1, wherein determining whether the selected text macro is compatible with the selected report structure comprises:
identifying the types of report sections for the selected report structure;
identifying one or more required types of report sections for the selected text macro; and
determining the text macro to be compatible if the required types of report sections for the selected text macro is a subset of the types of report sections for the selected report structure.

11. The method of claim 1, further comprising:
if the selected text macro is incompatible with the selected report structure, retrieving at least one report structure compatible with the selected text macro, the retrieval of the compatible report structure comprising:
i) for each of a plurality of potentially compatible report structure, determining the types of report sections for the potentially compatible report structure; and
ii) determining a potentially compatible report structure to be compatible if each of one or more required types of report sections for the selected text macro is a subset of the types of report sections for the potentially compatible report structure.

12. The method of claim 1, further comprising:
for each of the types of report sections for the selected report structure, creating a report section and associating the created report section with the type;
and if the selected text macro is compatible, updating at least one of the created report sections with a text block of the selected text macro that is associated with a type of report section that matches the type associated to the at least one created report section.

13. The method of claim 11, further comprising:
receiving at least one report section entry for updating the at least one created report section;
saving the updated at least one report section to form a medical record.

14. The method of claim 1, further comprising:
prior to receiving a text macro selection, retrieving one or more section-specific text macros, each section-specific text macro containing one text block and being applicable to all medical procedure types;
prior to receiving a text macro selection, for at least one of the retrieved section-specific text macro, determining whether the at least one retrieved section-specific text macro is associated with a type of report section that matches one of the one or more types of report sections for the selected report structure;
if the type of report section associated to the at least one section-specific text macro matches, prior to receiving a text macro selection:
i) creating a report section;
ii) associating the created report section with the type; and
iii) updating the created report section with the text block of the at least one section-specific text macro.

15. The method of claim 1, wherein the medical record creation request is for the first completed medical procedure and a second completed medical procedure, the request further indicating at least one medical procedure property of the second completed medical procedure, the method further comprising:
retrieving one or more second relevant text macros being relevant to the second completed medical procedure, each of the text macros comprising at least one text block;
selecting a second report structure based on the at least one medical procedure property of the second medical procedure, the second report structure indicating a second set of one or more types of report sections for completing the medical record;
receiving a second text macro selection request comprising a selected second text macro selected from second relevant text macros; and
determining whether the selected second text macro is compatible with the selected second report structure based on the types of report sections for the second selected structure and the at least one text block of the selected second text macro.

16. The method of claim 15, further comprising ordering the one or more relevant first text macros and the one or more relevant second text macros based on the first medical procedure and the second medical procedure, wherein text macros being relevant to the more recent of the first and second medical procedures are given a higher order.

17. The method of claim 15, further comprising:
for each type of report sections for the selected first report structure and for the selected second report structure, creating a report section and associating the created report section with the type, wherein a type being indicated by both first and second selected report structure is created once and associated with both report structures,
if the selected first text macro is compatible, updating at least one of the created report sections with a text block of the selected first text macro that is associated with a type of report section that matches the type associated to the at least one created report section;
if the selected second text macro is compatible, updating at least one of the created report sections with a text block of the selected second text macro that is associated with a type of report section that matches the type associated to the at least one created report section;
saving report sections associated with a first medical record; and
saving report sections associated with the second report structure within a second medical record separate from the first medical record.

18. A method for creating a new text macro to be used for completing a medical record, the method comprising:
receiving a text macro creation request for creating the new text macro; and
for one or more populated report sections of a selected report structure:
i) storing the content of the populated report section in a text block of the new text macro; and
ii) associating the text block with the report section type of the populated report section.

19. The method of claim 18, further comprising:
receiving a procedure-specific selection for the new text macro; and
storing the new procedure-specific selection as metadata of the new text macro.

20. The method of claim 19, further comprising:
receiving a user-specific selection for the new text macro; and
storing the new user-specific selection as metadata of the new text macro.

21. A system for completing a medical record comprising:
a memory for storing a plurality of instructions;
a data storage device; and
a processor coupled to the memory, the processor configured for:
receiving at a first client workstation a medical record creation request for at least a first completed medical procedure, the request indicating at least one medical procedure property of the first completed medical procedure;
retrieving one or more first relevant text macros, each of the text macros comprising at least one text block;
selecting a first report structure based on the at least one medical procedure property of the first completed medical procedure, the first report structure indicating a first set of one or more types of report sections for completing the medical record;
receiving a first text macro selection request comprising a first selected text macro selected from the retrieved first relevant text macros; and
determining whether the selected first text macro is compatible with the selected first report structure based on the types of report sections for the first selected report structure and the at least one text block of the selected first text macro.

22. The system of claim 21, wherein retrieving the one or more first relevant text macros comprises determining whether a normal report is available for the medical procedure type, the normal report indicating a normal text macro to be selected.

23. The system of claim 22, the processor being further configured for: if a normal report is available, selecting the normal text macro as the first selected text macro.

24. The system of claim 23, wherein determining whether a normal report is available comprises:
retrieving one or more normal reports that are available for the medical procedure, each normal report comprising a ranked user-level property; and
selecting as the available normal report the retrieved normal report having the highest ranked user-level property.

25. The system of claim 21, wherein the one or more relevant text macros are determined according to matching of one or more procedure-specific properties of the medical procedure with one or more procedure-specific properties metadata of each of a plurality of available text macros.

26. The system of claim 25, wherein the one or more relevant text macros are further determined according to one or more user-level metadata of each of the matching available text macros.

27. The system of claim 25, wherein the procedure-specific properties are selected from: procedure type, modality type, body part, or a combination thereof.

28. The system of claim 26, wherein the one or more user-specific properties are selected from: user identification, group identification or system identification.

29. The system of claim 26, wherein the one or more procedure-specific properties and the user-level metadata of any one of the text macros indicates a relevancy of the text macro, the processor being further configured for:
displaying the retrieved first relevant text macros by order of relevancy of each of the retrieved first relevant text macros.

30. The system of claim 21, wherein determining whether the selected text macro is compatible with the selected report structure comprises:
identifying the types of report sections for the selected report structure;
identifying one or more required types of report sections for the selected text macro; and
determining the text macro to be compatible if the required types of report sections for the selected text macro is a subset of the types of report sections for the selected report structure.

31. The system of claim 21, the processor being further configured for:
if the selected text macro is incompatible with the selected report structure, retrieving at least one report structure compatible with the selected text macro, the retrieval of the compatible report structure comprising:
i) for each of a plurality of potentially compatible report structure, determining the types of report sections for the potentially compatible report structure; and
ii) determining a potentially compatible report structure to be compatible if each of one or more required types of report sections for the selected text macro is a subset of the types of report sections for the potentially compatible report structure.

32. The system of claim 21, the processor being further configured for:
for each of the types of report sections for the selected report structure, creating a report section and associating the created report section with the type;
and if the selected text macro is compatible, updating at least one of the created report sections with a text block of the selected text macro that is associated with a type of report section that matches the type associated to the at least one created report section.

33. The system of claim 31, the processor being further configured for:
receiving at least one report section entry for updating the at least one created report section;
saving the updated at least one report section to form a medical record.

34. The system of claim 21, the processor being further configured for:
prior to receiving a text macro selection, retrieving one or more section-specific text macros, each section-specific text macro containing one text block and being applicable to all medical procedure types;
prior to receiving a text macro selection, for at least one of the retrieved section-specific text macro, determining whether the at least one retrieved section-specific text macro is associated with a type of report section that matches one of the one or more types of report sections for the selected report structure;
if the type of report section associated to the at least one section-specific text macro matches, prior to receiving a text macro selection:
i) creating a report section;
ii) associating the created report section with the type; and
iii) updating the created report section with the text block of the at least one section-specific text macro.

35. The system of claim 21, wherein the medical record creation request is for the first completed medical procedure and a second completed medical procedure, the request further indicating at least one medical procedure property of the second completed medical procedure, the processor being further configured for:
retrieving one or more second relevant text macros being relevant to the second completed medical procedure, each of the text macros comprising at least one text block;
selecting a second report structure based on the at least one medical procedure property of the second medical procedure, the second report structure indicating a second set of one or more types of report sections for completing the medical record;
receiving a second text macro selection request comprising a selected second text macro selected from second relevant text macros; and
determining whether the selected second text macro is compatible with the selected second report structure based on the types of report sections for the second selected structure and the at least one text block of the selected second text macro.

36. The system of claim 35, the processor being further configured for ordering the one or more relevant first text macros and the one or more relevant second text macros based on the first medical procedure and the second medical procedure, wherein text macros being relevant to the more recent of the first and second medical procedures are given a higher order.

37. The system of claim 35, the processor being further configured for:
for each type of report sections for the selected first report structure and for the selected second report structure, creating a report section and associating the created report section with the type, wherein a type being indicated by both first and second selected report structure is created once and associated with both report structures,
if the selected first text macro is compatible, updating at least one of the created report sections with a text block of the selected first text macro that is associated with a type of report section that matches the type associated to the at least one created report section;
if the selected second text macro is compatible, updating at least one of the created report sections with a text block of the selected second text macro that is associated with a type of report section that matches the type associated to the at least one created report section;
saving report sections associated with a first medical record; and
saving report sections associated with the second report structure within a second medical record separate from the first medical record.

38. A system for creating a new text macro to be used for completing a medical record, the system comprising:
a memory for storing a plurality of instructions;
a data storage device; and
a processor coupled to the memory, the processor configured for:
receiving a text macro creation request for creating the new text macro; and
for one or more populated report sections of a selected report structure:
i) storing the content of the populated report section in a text block of the new text macro; and
ii) associating the text block with the report section type of the populated report section.

39. The system of claim 38, the processor being further configured for:
receiving a procedure-specific selection for the new text macro; and
storing the new procedure-specific selection as metadata of the new text macro.

40. The system of claim 39, the processor being further configured for:
receiving a user-specific selection for the new text macro; and
storing the new user-specific selection as metadata of the new text macro.

41. A physical non-transient computer-readable medium upon which a plurality of instructions are stored, the instructions for performing the steps of the method as claimed in claim 1.
